(19) United States
(12) Patent Application Publication
(10) Pub. No.: US 2014/0324290 A1
(43) Pub. Date: Oct. 30, 2014

(54) Traction and Cornering Properties of a Motor Vehicle

(71) Applicant: FORD GLOBAL TECHNOLOGIES, LLC, Dearborn, MI (US)

(72) Inventors: Jens Dornhege, Pulheim (DE); Derek K. Ward, Duisburg (DE); Lucian Lippok, Koln (DE)

(73) Assignee: FORD GLOBAL TECHNOLOGIES, LLC, Dearborn, MI (US)

(21) Appl. No.: 13/873,490

(22) Filed: Apr. 30, 2013

(51) Int. Cl. B62D 9/00

(52) U.S. Cl. CPC B62D 9/002
USPC 701/41

(57) ABSTRACT

A method for controlling cornering of a motor vehicle having a front wheel drive and an electronically controllable locking differential. A motion model of the motor vehicle is calculated on the basis of the control inputs of a vehicle driver, a lateral movement parameter of the motor vehicle is measured. Deviations of the measured lateral movement parameter to the modeled movement, and the rotational speed of a front wheel which is on the inside during cornering from such a rotational speed of a front wheel which is on the outside are determined. The deviations are reduced if the rotational speed of the front wheel which is on the inside is not lower than the rotational speed of the front wheel which is on the outside, and if the measured lateral movement parameter deviates from the modeled lateral movement parameter. Reduction of the deviation is carried out by applying a locking torque to the locking differential and by single-sided braking of at least one wheel.

### BACKGROUND OF THE INVENTION

1. Field of the Invention

This invention relates generally to a control method during cornering of a motor vehicle having a front wheel drive and an electronically controllable locking differential.

2. Description of the Prior Art

In front-wheel-driven motor vehicles with a large driving force, owing to the centrifugal forces which occur during cornering, the driven wheel that is on the inside during cornering is relieved. In this context, the grip of the driven wheel which is on the inside decreases on the underlying surface with the result that slip can occur, that is to say for a certain time the absolute value of the track speed of a point arranged on the lateral surface of the wheel is higher than the absolute value of the motion speed, related to the underlying driving surface, of the contact face of the wheel with the underlying driving surface. The slip brings about loss of grip of the wheel, as a result of which the wheel can apply no force or less force to the underlying driving surface. In this context, as well as greater wear of the wheel, it is problematic, in particular, that only a reduced lateral acceleration of the motor vehicle can be achieved, as a result of which the motor vehicle follows a correspondingly enlarged bend radius and in the worst case is carried out of the bend.

Since the problem is well known, various approaches can be found in the prior art for reducing or preventing the slip of the front wheel that is on the inside during cornering. It is therefore known, for example, to limit the engine torque as a function of the slip which occurs, which, however, runs counter to the driver's intention to accelerate the motor vehicle and is therefore experienced as a strong intervention into the controllability. Furthermore, it is known that braking of the slipping wheel can be carried out. However, in this context, movement energy is wasted, greater wear of the brakes occurs and the engine power is not completely converted into acceleration of the motor vehicle. Mechanical limited locking differentials, in which the equalization effect of the simple differential, which distributes the driving torque to the wheels of an axle, is limited are also known. However, mechanical locking differentials adversely affect the control behavior of the motor vehicle in many situations and require a compromise between the behavior when the slip occurs and the customary driving behavior.

For this reason, a more flexible solution has been proposed in which the locking torque of the locking differential can be electronically predefined. However, in this context in many situations an undesired negative effect also occurs on the feedback of the control torque to the driver, which feedback the driver intentionally or unintentionally uses to control the motor vehicle.

### SUMMARY OF THE INVENTION

A method for controlling a cornering motor vehicle having a front wheel drive and an electronically controllable locking differential. Movement model of the motor vehicle is calculated on the basis of control of a vehicle driver, a lateral movement parameter of the motor vehicle is measured. Deviations of the measured lateral movement parameter from a modeled front wheel which is on the inside during cornering, and the rotational speed of a front wheel which is on the inside during cornering from such a rotational speed of a front wheel which is on the outside are determined. The deviations are reduced if the rotational speed of the front wheel which is on the inside is not lower than the rotational speed of the front wheel which is on the outside, and if the measured lateral movement parameter deviates from the modeled lateral movement parameter. Reduction of the deviation is carried out by applying a locking torque to the locking differential and by single-sided braking of at least one wheel.

The invention has the advantage that a respectively suitable procedure for reducing the slip can be selected as a function of the situation. However, the measures are effective here only when the actual movement behavior of the motor vehicle deviates from a modeled behavior. As a result, the restriction of the controllability of the motor vehicle which occurs according to the prior art can be reduced and at the same time the cornering behavior of the motor vehicle can be improved in the direction of the presetting of the movement model.

The scope of applicability of the preferred embodiment will become apparent from the following detailed description, claims and drawings. It should be understood, that the description and specific examples, although indicating preferred embodiments of the invention, are given by way of illustration only. Various changes and modifications to the described embodiments and examples will become apparent to those skilled in the art.

### DESCRIPTION OF THE DRAWINGS

The invention will be more readily understood by reference to the following description, taken with the accompanying drawing, in which:

FIG. 1 is a schematic diagram showing a motor vehicle, wherein some of the elements which are irrelevant to the explanation and are conventional have been omitted.

### DESCRIPTION OF THE PREFERRED EMBODIMENT

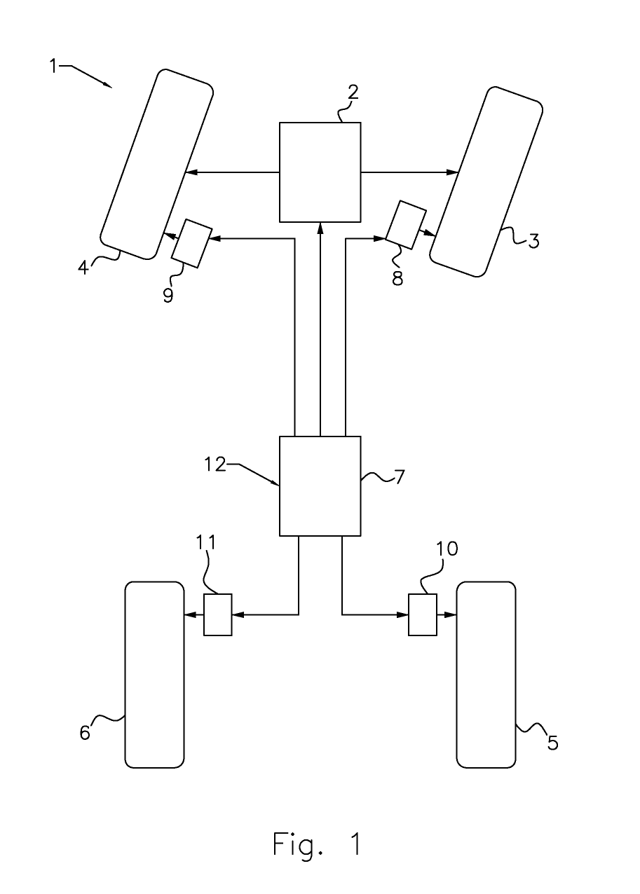

The motor vehicle 1 shown in FIG. 1 has a front wheel drive, with the result that the front wheels 3 and 4 are used not only for steering the motor vehicle but also for its drive. The transmission of driving torque, produced and provided by an engine (not illustrated) to the two front wheels 3, 4 is performed by an electronically controllable locking differential 2, to which a locking torque can be applied in order to limit the equalizing effect of a differential gear. The locking differential 2 is controlled by a controlling unit 7, which also controls the brakes 8-11, which are arranged at the front wheels 3, 4 as well as the rear wheels 5, 6. The control unit 7 receives a number of input signals 12, which include various measurement signals, but also control pre-settings of the motor vehicle driver and serve to bring about the movement model of the motor vehicle. The control unit 7 is designed to carry out the method according to the invention, as a result of which a better cornering behavior, less wear of the tires and increased driving safety accompanied at the same time by greater driving comfort are made possible.

Alternatively, a second control unit which is separate from the brake system can also control the locking differential 2, but both control units access the same movement model.

The control method includes various steps. A movement model of the motor vehicle is used to calculate movement of the vehicle on the basis of control pre-settings by a vehicle driver.

A lateral movement parameter of the motor vehicle is then measured. The lateral movement parameter is preferably at least one of the lateral vehicle acceleration, a measure of the vehicle yawing and a measure of the distance traveled laterally in an instantaneous direction of movement of the motor vehicle in a time period.

Deviation of the measured lateral movement parameter from the modeled lateral movement parameter of the movement model is determined.

Deviation between rotational speed of the front wheel 3, which is on the inside during cornering, from the rotational speed of the front wheel 4, which is on the outside during cornering is determined.

Deviation between the rotational speeds of wheels 3, 4 is reduced, provided (i) the rotational speed of the front wheel 3, which is on the inside, is not lower than the rotational speed of the front wheel 4, which is on the outside, and (ii) the measured lateral movement parameter deviates from the modeled lateral movement parameter. According to the invention, the reduction of the deviation between the rotational speeds of wheels 3 and 4 takes place as a function of operating parameters of the motor vehicle determined during the cornering by applying a locking torque to the locking differential 2 and/or by single-sided braking of wheel 3, which is on the inside during cornering, of the motor vehicle.

In the alternative, the rotational speed of the front wheel 3, which is on the inside, is reduced provided (i) the rotational speed of the front wheel 3, which is on the inside is lower than the rotational speed of the front wheel 4, which is on the outside, and (i) the measured lateral movement parameter deviates from the modeled lateral movement parameter.

The operating parameters which are determined during cornering may include, for example, the lateral acceleration, a measure of the yawing, that is to say the rotation of the motor vehicle along a vertical axis, the rotational speeds of the wheels, the torque which is transmitted by one wheel, the speed of the motor vehicle, the inclination of the passenger compartment, the deflection of the steering wheel, the ambient temperature, the humidity of the air, the air pressure, the tire pressure or a combination of several of the abovementioned parameters.

The lateral acceleration of the motor vehicle is preferably determined. A locking torque is applied to the locking differential 2 under the additional condition that the lateral acceleration is greater than a reference acceleration. Apart from μ-split situations, the rotational speed of the front wheel 3, which is on the inside, will be greater than that of the front wheel 4, which is on the outside, only when sufficient transmission of lateral force takes place, and the lateral acceleration therefore exceeds a specific amount. The lateral acceleration therefore helps to differentiate μ-split situations from slip during cornering, with the result that a separate treatment becomes possible.

The single-sided braking of the at least one wheel 3, which is on the inside during cornering, of the motor vehicle 1 can be carried out under the additional condition that the lateral acceleration is lower than a first reference acceleration. Below the reference acceleration, the single-sided braking is more efficient for increasing the grip and the yawing than the control by means of the locking differential. However, above the reference acceleration, the single-sided braking can also advantageously be carried out in addition to the application of the locking torque to the locking differential.

Alternatively or additionally, the braking of the at least one wheel 3, which is on the inside during cornering, of the motor vehicle 1 can also be carried out under the additional condition that the deviation between the rotational speeds of the front wheel 3, which is on the inside, and of the front wheel 4, which is on the outside, does not decrease at least by a predetermined amount during a predetermined time period during which the locking torque is applied to the locking differential. The single-side braking is considered here to be a waste of the kinetic energy of the motor vehicle and is preferably used only when it is apparent that the use of the locking differential 2 does not sufficiently reduce the slip. The single-sided braking can be carried out here as an alternative to or in addition to the application of the locking torque to the locking differential 2. If single-sided braking is carried out during the application of the locking torque to the locking differential 2, a rear wheel 5, which is on the inside during cornering, of the motor vehicle 1 is preferably braked. This can be carried out under the additional condition that the lateral acceleration of the motor vehicle 1 is greater than a second reference acceleration. The single-sided braking in addition to the use of the locking differential 2 can serve here, for example, to increase the yawing of the vehicle.

The at least one wheel, which is on the inside during cornering, is preferably a rear wheel 5 of the motor vehicle 1. The braking of a rear wheel 5 does not constitute a conflict with the front wheel drive of the motor vehicle 1.

The locking torque is advantageously selected as a function of the deviation between the rotational speeds of the front wheel 3, which is on the inside, and the front wheel 4, which is on the outside. As a result, the strength of the intervention into the driving behavior of the motor vehicle can be made dependent on the degree to which the slip occurs.

A straight-ahead signal can be determined which has a maximum absolute value if the motor vehicle 1 is traveling straight-ahead and always has relatively low absolute values the greater the degree of cornering of the motor vehicle. The straight-ahead signal can also be used according to the invention as a lateral movement parameter and/or as an operating parameter, which is determined during cornering. The straight-ahead signal is determined preferably on the basis of at least one of the following: steering wheel modulation, yawing of the motor vehicle or the lateral acceleration of the motor vehicle.

In embodiments of the method according to the invention in which a straight-ahead signal is determined, it is possible to also select the locking torque as a function of a complementary value of the straight-ahead signal. As a result, the locking torque becomes a function of the degree of cornering. In particular, the locking torque can become all the greater the smaller the straight-ahead signal becomes, and the greater the degree to which the motor vehicle therefore carries out or is to carry out cornering. What is referred to as a complementary value here is a value that becomes small if the original value becomes large, and large if the original value becomes small. If the straight-ahead signal is restricted to a range from 0 to 1, the complementary value can be acquired by subtracting the straight-ahead signal from 1.

The locking torque is preferably reduced if the measured lateral movement parameter of the motor vehicle becomes greater than the modeled lateral movement parameter. In such a case, the bend on which the motor vehicle is actually driving becomes sharper than the modeled bend, as a result of which, on the one hand, danger can arise for the vehicle occupants or further persons, but, on the other hand, the need to reduce the slip is reduced entirely. The locking torque can also be reduced if slip occurs at the front wheel 4, which is at the outside during cornering, which may be a sign, for example, that a slippery underlying driving surface is the cause of the problem.

The braking of the at least one wheel 3, 5, which is on the inside during cornering, is performed in preferred embodiments of the invention only under the further condition that the measured lateral movement parameter of the motor vehicle 1 is smaller than the modeled lateral movement parameter.

During the braking of the at least one wheel 3,5, which is on the inside during cornering, the braking force which is applied is preferably selected as a function of the deviation between the rotational speeds of the front wheel 3, which is on the inside, and of the front wheel 4, which is on the outside. The applied braking force is therefore a function of slip which actually occurs, which avoids an abrupt driving behavior of the motor vehicle. In this context, the braking force is preferably selected as a monotonously rising function of a difference between the rotational speeds of the front wheel 3, which is on the inside, and of the front wheel 4, which is on the outside.

A second aspect of the invention relates to a computer-readable storage medium having a control program which is executed by a control unit of a motor vehicle 1, which carries out the method of the first aspect of the invention.

A third aspect of the invention is directed to a motor vehicle 1 having a front wheel drive and an electronically controllable locking differential 2. The motor vehicle 1 comprises a control unit 7, which is designed to carry out the method according to the invention.

In accordance with the provisions of the patent statutes, the preferred embodiment has been described. However, it should be noted that the alternate embodiments can be practiced otherwise than as specifically illustrated and described.

The invention claimed is:

1. A control method for a motor vehicle (1) having a front wheel drive and an electronically controllable locking differential (2) during cornering, comprising the steps of:
calculating a movement model of the motor vehicle (1) referenced to control presettings of a driver of the motor vehicle (1);
measuring a lateral movement parameter of the motor vehicle (1);
determining a deviation of a measured lateral movement parameter from a modeled lateral movement parameter of the movement model;
determining a deviation between a rotational speed of a front wheel (3) which is on an inside during cornering from a rotational speed of a front wheel (4) which is on an outside during cornering;
reducing the deviation between the rotational speeds provided (i) the rotational speed of the front wheel (3) which is on the inside is not lower than the rotational speed of the front wheel (4) which is on the outside and (ii) the measured lateral movement parameter deviates from the modeled lateral movement parameter;
reducing the rotational speed of the front wheel which is on the inside provided (i) the rotational speed of the front wheel which is on the inside is lower than the rotational speed of the front wheel which is on the outside and (ii) the measured lateral movement parameter deviates from the modeled lateral movement parameter;
wherein reduction of the deviation between the rotational speeds or reduction of the rotational speed of the front wheel which is on the inside takes place as a function of operating parameters of the motor vehicle (1) determined during cornering by applying a locking torque to the locking differential (2) and/or by single-sided braking of at least one wheel (3, 5), which is on the inside during cornering, of the motor vehicle (1).

2. The method of claim 1 further comprising:
determining a lateral acceleration of the motor vehicle (1); and
applying a locking torque to the locking differential (2) provided lateral acceleration is greater than a reference acceleration.

3. The method of claim 1, further comprising:
performing single-sided braking of the at least one wheel (3, 5), which is on the inside during cornering, of the motor vehicle (1) provided that the lateral acceleration is lower than a first reference acceleration.

4. The method of claim 3, wherein braking of the at least one wheel (3, 5), which is on the inside during cornering, of the motor vehicle (1) is carried out provided that the deviation between the rotational speeds of the front wheel (3), which is on the inside, and of the front wheel (4), which is on the outside, does not decrease at least by a predetermined amount during a predetermined time period during which the locking torque is applied to the locking differential (2).

5. The method of claim 4 wherein during the application of the locking torque to the locking differential (2) a rear wheel (5), which is on the inside during cornering, of the motor vehicle (1) is braked if lateral acceleration of the motor vehicle (1) is higher than a second threshold acceleration.

6. The method of claim 1 wherein the at least one wheel (3, 5), which is on the inside during cornering, is a rear wheel (5) of the motor vehicle (1).

7. The method of claim 2 wherein a magnitude of locking torque that is applied is determined as a function of the deviation between the rotational speeds of the front wheel (3) which is on the inside and the front wheel (4) which is on the outside.

8. The method of claim 1, further comprising:
determining a straight-ahead signal which has a maximum absolute value if the motor vehicle (1) is traveling straight-ahead and which is reduced while cornering of the motor vehicle (1) is increasing.

9. The method of claim 8, further comprising:
determining the straight-ahead signal with reference to at least one of the following: steering wheel modulation, yawing of the motor vehicle (1) and lateral acceleration of the motor vehicle (1).

10. The method of claim 8, wherein a locking torque is selected as a function of a complementary value of the straight-ahead signal.

11. The method of claim 2, wherein the locking torque is reduced if the measured lateral movement parameter of the motor vehicle (1) becomes greater than the modeled lateral movement parameter.

12. The method of claim 2, wherein the locking torque is reduced if slip occurs at the front wheel (4) which is at the outside during cornering.

13. The method of claim 3, wherein the braking of the at least one wheel (3, 5), which is on the inside during cornering, is performed provided that the measured lateral movement parameter of the motor vehicle (1) is smaller than the modeled lateral movement parameter.

14. The method of claim 3, further comprising:
selecting a braking force which is applied for the braking of the at least one wheel (3, 5), which is on the inside during cornering, as a function of the deviation between the rotational speeds of the front wheel (3), which is on the inside, and of the front wheel (4), which is on the outside.

15. The method of claim 3, wherein the single-sided braking is applied to a wheel (3, 5), which is on the inside, provided the rotational speed of the front wheel (3), which is on the inside, is less than the rotational speed of the front wheel (4), which is on the outside.

16. The method of claim 1, wherein the braking force is selected as a continuously rising function of a difference between the rotational speeds of the front wheel (3), which is on the inside, and the front wheel (4), which is on the outside.

17. A motor vehicle (1) including:
a front wheel drive;
an electronically controllable locking differential (2); and
a control unit (7) which is configured to calculate a movement model of the motor vehicle (1) with reference to control presettings of a vehicle driver of the motor vehicle (1); measure a lateral movement parameter of the motor vehicle (1); determine a deviation of a measured lateral movement parameter from a modeled lateral movement parameter of the movement model; determine a deviation between a rotational speed of a front wheel (3) which is on an inside during cornering from a rotational speed of a front wheel (4) which is on an outside during cornering; reduce the deviation between the rotational speeds provided (i) the rotational speed of the front wheel (3) which is on the inside is not lower than the rotational speed of the front wheel (4) which is on the outside and (ii) the measured lateral movement parameter deviates from the modeled lateral movement parameter; and reduce the rotational speed of the front wheel which is on the inside provided (i) the rotational speed of the front wheel which is on the inside is lower than the rotational speed of the front wheel which is on the outside and (ii) the measured lateral movement parameter deviates from the modeled lateral movement parameter.
